(19) United States
(12) Patent Application Publication
(10) Pub. No.: US 2015/0347862 A1
(43) Pub. Date: Dec. 3, 2015

(54) IMAGE PROCESSING APPARATUS, IMAGE PROCESSING METHOD, IMAGE PROCESSING SYSTEM, AND NON-TRANSITORY COMPUTER READABLE MEDIUM STORING PROGRAM

(71) Applicant: FUJI XEROX CO., LTD., Tokyo (JP)

(72) Inventor: Makoto SASAKI, Kanagawa (JP)

(73) Assignee: FUJI XEROX CO., LTD., Tokyo (JP)

(21) Appl. No.: 14/531,231

(22) Filed: Nov. 3, 2014

(30) Foreign Application Priority Data
May 30, 2014 (JP) 2014-113459

(51) Int. Cl. G06K 9/46; G06T 5/00; G06K 9/00; G06K 9/62; G06T 7/00

(52) U.S. Cl. CPC G06K 9/46; G06K 9/6215; G06T 7/004; G06K 9/00268; G06T 5/00; G06K 2009/4666

(57) ABSTRACT

Provided is an image processing apparatus including an image information acquiring unit that acquires image information of an image, a position information acquiring unit that acquires position information indicating a representative position of a designated region which is designated as a specific image region from the image by a user, and a region detection unit that detects the designated region from the position information, wherein region detection unit includes a range setting unit that sets a first range that is a range of first target pixels, or that changes a second range that is a range which is set for a second target pixel, and a determination unit that determines a designated region to which the first target pixel or the second target pixel belongs.

### CROSS-REFERENCE TO RELATED APPLICATIONS

This application is based on and claims priority under 35 USC 119 from Japanese Patent Application No. 2014-113459 filed May 30, 2014.

### BACKGROUND

### Technical Field

The present invention relates to an image processing apparatus, an image processing method, an image processing system, and a non-transitory computer readable medium storing a program.

### SUMMARY

According to an aspect of the invention, there is provided an image processing apparatus including:

an image information acquiring unit that acquires image information of an image;

a position information acquisition unit that acquires position information indicating a representative position of a designated region which is designated as a specific image region from the image by a user; and

a region detection unit that detects the designated region from the position information,

wherein region detection unit includes:

a range setting unit that sets a first range that is a range of first target pixels which are target pixels set with respect to a reference pixel selected from pixels belonging to the designated region and which are determined as to whether or not the target pixels are included in the designated region, or that changes a second range that is a range which is set for a second target pixel which is the selected target pixel and which includes a reference pixel for determining a designated region in which the second target pixel is included; and

a determination unit that determines a designated region to which the first target pixel or the second target pixel belongs.

### BRIEF DESCRIPTION OF THE DRAWINGS

Exemplary embodiments of the present invention will be described in detail based on the following figures, wherein:

FIG. 1 is a diagram illustrating a configuration example of an image processing system according to the present exemplary embodiment;

FIG. 2 is a block diagram illustrating a functional configuration example of the image processing apparatus according to the present exemplary embodiment;

FIGS. 3A and 3B are diagrams illustrating an example of a method of interactively performing a task for designating a designated region;

FIGS. 4A to 4C illustrate aspects in which designated regions are cut out from an image illustrated in FIG. 3B by a region expanding method;

FIG. 5 illustrates an aspect in which a “first designated region” and a “second designated region” are cut out by the region expanding method, for an image illustrated in FIG. 3A;

FIGS. 6A to 6C illustrate examples of a screen displayed on the display screen of a display device, when the user selects a designated region;

FIG. 7 illustrates an example of a screen displayed on the display screen of the display device, when the image processing is performed;

FIGS. 8A to 8C are diagrams describing a region expanding method in the related art;

FIGS. 9A to 9E are diagrams illustrating aspects in which an image is divided into two designated regions, when two seeds are given, by the region expanding method in the related art;

FIG. 10 is a block diagram illustrating a functional configuration example of a region detection unit in a first exemplary embodiment;

FIG. 11A is a diagram illustrating an original image to be divided into designated regions, and FIG. 11B is a diagram illustrating a reference pixel;

FIG. 12 is a diagram describing a first range;

FIG. 13 illustrates a result of performing determination on target pixels belonging to a first range illustrated in FIG. 12, based on Euclidean distance;

FIGS. 14A and 14B are diagrams illustrating a method of determining influence;

FIG. 15 illustrates a result of performing determination on target pixels in the first range illustrated in FIG. 12, by a method based on strength;

FIGS. 16A to 16H are diagrams illustrating an example of a process of sequentially labelling by a region expanding method based on strength;

FIGS. 17A to 17H are diagrams illustrating an example of a process of sequentially labelling by a region expanding method according to a second exemplary embodiment;

FIGS. 18A and 18B are diagrams illustrating a case of reversing the order of rows and columns;

FIG. 19 is a flowchart describing an operation of a region detection unit in the first exemplary embodiment and the second exemplary embodiment;

FIG. 20 is a diagram illustrating target pixels selected by a pixel selection unit and a second range which is set by a range setting unit;

FIG. 21 is a diagram illustrating a result of determination according to the present exemplary embodiment;

FIG. 22 is a flowchart describing an operation of the region detection unit in a third exemplary embodiment;

FIG. 23 is a flowchart describing an operation of the region detection unit in a fourth exemplary embodiment;

FIGS. 24A and 24B are conceptual diagrams in the case of improving visibility for the original image by performing a Retinex process; and

FIG. 25 is a diagram illustrating a hardware configuration of the image processing apparatus.

### DETAILED DESCRIPTION

Hereinafter, exemplary embodiments of the present invention will be described in detail with reference to the accompanying drawings.

<Background of Invention>

For example, when the quality of a color image is adjusted, the adjustment may be performed on an entire color image or respective regions of the color image. Elements for displaying the color image generally includes color components such as RGB, brightness and chromaticity such as L*a*b*, and brightness, hue, and saturation such as HSV. Representative examples for controlling image quality includes histogram control of the color component, contrast control of the brightness, histogram control of the brightness, bandwidth control of the brightness, hue control, saturation control, and the like. In recent years, it is noted to control image quality representing visibility such as Retinex. In a case of controlling image quality based on the bandwidth of color and brightness, in particular, when the image quality of only a specific region is adjusted, a process of cutting out the region is required.

Meanwhile, since a range of image processing has spread with an increase of information and communication technology (ICT) devices in recent years, various approaches for the above image processing and image editing are considered. In this case, the advantage of the ICT devices represented by tablet terminals is intuitive due to touch panels or the like, and characterized in performing the image processing and image editing with an increase in user interactivity.

Based on the above situation, in the exemplary embodiments of the present invention, cut out of a particular region or image quality adjustment are performed using a following image processing system 1.

<Description of Entire Image Processing System>

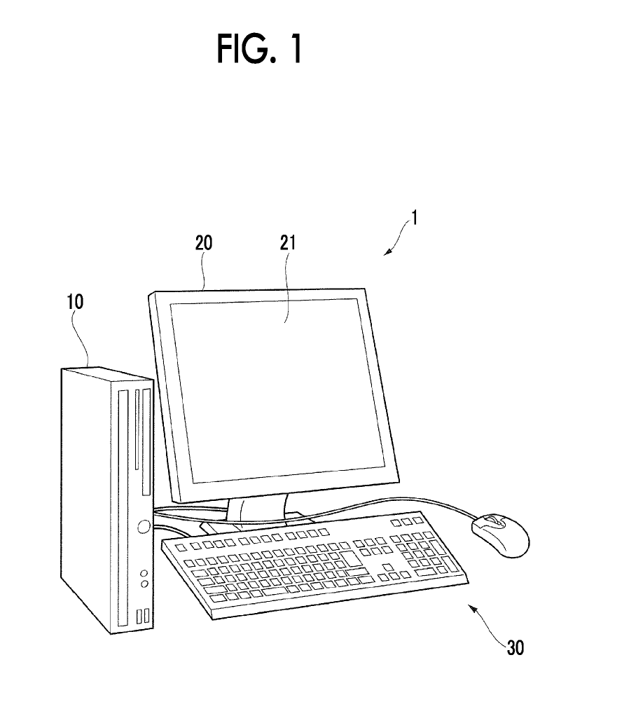

FIG. 1 is a diagram illustrating a configuration example of an image processing system 1 according to the present exemplary embodiment.

As illustrated, the image processing system 1 according to the present exemplary embodiment includes an image processing apparatus 10 that performs an image processing on image information of an image displayed on a display device 20, the display device 20 that receives image information created by the image processing apparatus 10 and displays an image based on the image information, and an input device 30 for a user to input various information to the image processing apparatus 10.

The image processing apparatus 10 is, for example, a so-called general purpose personal computer (PC). Then, creation of image information is to be performed by the image processing apparatus 10 causing various types of application software to be operated, under the management by an operating system (OS).

The display device 20 displays an image on a display screen 21. The display device 20 is configured by those with a function of displaying an image by additive color mixing, such as a liquid crystal display for a PC, an LCD TV, or a projector. Accordingly, the display type of the display device 20 is not limited to a liquid crystal type. In addition, in an example illustrated in FIG. 1, the display screen 21 is provided in the display device 20, but when for example, a projector is used as the display device 20, the display screen 21 is a screen provided outside the display device 20, or the like.

The input device 30 is configured with a keyboard or the like. The input device 30 is used for a start or end of application software for performing image processing, and for inputting an instruction for performing image processing to the image processing apparatus 10 by the user at the time of performing the image processing, details will be described.

The image processing apparatus 10 and the display device 20 are connected through a digital visual interface (DVI). In addition, they may be connected through a high-definition multimedia interface (HDMI: registered trademark), DisplayPort, or the like, instead of the DVI.

Further, the image processing apparatus 10 and the input device 30 are connected through, for example, a universal serial bus (USB). In addition, they may be connected through IEEE1394, RS-232C, or the like instead of the USB.

In such an image processing system 1, an original image which is an image prior to first image processing is first displayed on the display device 20. Then, if the user inputs an instruction for causing the image processing apparatus 10 to perform an image processing, using the input device 30, the image processing is performed on image information of the original image by the image processing apparatus 10. The result of the image processing is reflected on an image displayed on the display device 20, and the image obtained from the image processing is displayed on the display device 20 while being redrawn. In this case, the user may perform the image processing interactively while viewing the display device 20, and perform the task of the image processing more intuitively and easily.

In addition, the image processing system 1 according to the present exemplary embodiment is not limited to the aspect of FIG. 1. For example, a tablet terminal may be illustrated as the image processing system 1. In this case, the tablet terminal includes touch panels, and an instruction from the user is input by the touch panel while an image is displayed on the touch panel. In other words, the touch panel functions as the display device 20 and the input device 30. Further, similarly, it is possible to use a touch monitor as an apparatus in which the display device 20 and the input device 30 are integrated. In this apparatus, a touch panel is used as the display screen 21 of the display device 20. In this case, the image information is created by the image processing apparatus 10, and an image is displayed on the touch monitor, based on the image information. Then, the user inputs an instruction for performing the image processing by touching the touch monitor.

<Description of Image Processing Apparatus>

Next, description will be given of the image processing apparatus 10.

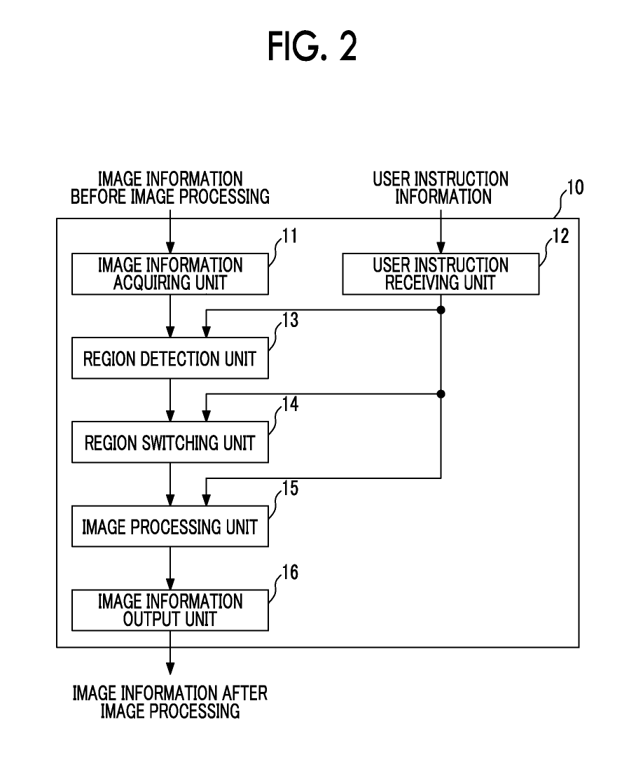

FIG. 2 is a block diagram illustrating a functional configuration example of the image processing apparatus 10 according to the present exemplary embodiment. In addition, in FIG. 2, those related to the present exemplary embodiment are selected and illustrated among various functions included in the image processing apparatus 10.

As illustrated, the image processing apparatus 10 according to the present exemplary embodiment includes an image information acquiring unit 11, a user instruction receiving unit 12, a region detection unit 13, a region switching unit 14, an image processing unit 15, and an image information output unit 16.

The image information acquiring unit 11 acquires image information of an image to be subjected to an image process. In other words, the image information acquiring unit 11 acquires image information of an original image which is an image prior to first image processing. The image information is, for example, video data (RGB data) of red, green, and blue (RGB) for performing display on the display device 20.

The user instruction receiving unit 12 is an example of a position information acquisition unit, and receives information from the user regarding an image processing input by the input device 30.

Specifically, the user instruction receiving unit 12 receives, as user instruction information, an instruction for designating a region designated as a particular image region by the user, among images displayed on the display device 20. In this case, the particular image region is an image region to be image-processed by the user. Actually, in the present exemplary embodiment, the user instruction receiving unit 12 acquires, as user instruction information, position information indicating a representative position of the designated region which is input by the user.

Although details will be described later, the user instruction receiving unit 12 receives, as user instruction information, an instruction for the user to select a region to be actually subjected to an image processing, among the designated regions. Further, the user instruction receiving unit 12 receives, as user instruction information, an instruction regarding a processing item, a processing amount and the like of image processing to be performed on the selected designated region by the user. More detailed description regarding the contents will be given later.

The present exemplary embodiment employs a method of interactively performing a task for designating a designated region as described below.

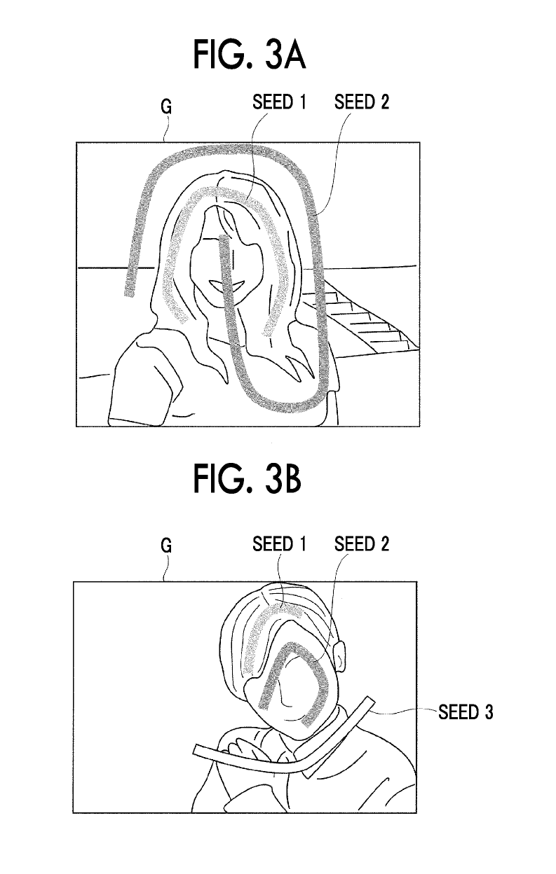

FIGS. 3A and 3B are diagrams illustrating an example of the method of interactively performing a task for designating a designated region.

FIG. 3A illustrates a case in which an image displayed on the display screen 21 of the display device 20 is an image G of a picture including a person captured as a foreground and a background captured behind the person. A case of selecting a hair portion of a person which is a foreground and a portion other than the hair as respective designated regions is illustrated. In other words, in this case, there are two designated regions. Hereinafter, a designated region of the hair portion is referred to as “first designated region”, and a designated region of the portion other than the hair is referred to as “second designated region”.

FIG. 3B illustrates a case in which an image displayed on the display screen 21 of the display device 20 is an image G of a picture including a person captured as a foreground and a background captured behind the person. A case of selecting a hair portion and a face portion of a person which is a foreground and a portion other than the hair and the face as respective designated regions is illustrated. In other words, in this case, there are three designated regions. Hereinafter, a designated region of the hair portion is referred to as “first designated region”, a designated region of the face portion is referred to as “second designated region”, and a designated region of a portion other than the hair and the face is referred to as “third designated region”.

The user respectively gives representative trajectories to the respective designated regions. The trajectory may be input by using the input device 30. Specifically, when the input device 30 is a mouse, a trajectory is drawn by dragging the image G displayed on the display screen 21 of the display device 20 by operating the mouse. Similarly, when the input device 30 is a touch panel, a trajectory is drawn by tracing and swiping the image G by using the user's finger, a touch pen, or the like. In addition, a point may be given instead of the trajectory. In other words, the user may give information indicating positions which are representatives to the respective designated regions such as the hair portion. It may be said that the user inputs the position information representing the representative position of the designated region. In addition, hereinafter, the trajectory, the point, and the like are referred to as “seeds”.

In the example of FIG. 3A, respective seeds are drawn on the hair portion and the portion other than hair (hereinafter, the seeds are respectively referred to as “seed 1” and “seed 2”). In the example of FIG. 3B, respective seeds are drawn on the hair portion, the face portion, and the portion other than hair and face (hereinafter, the seeds are respectively referred to as “seed 1”, “seed 2”, and “seed 3”).

The region detection unit 13 detects a designated region from an image displayed on the display device 20, based on the user instruction information received in the user instruction receiving unit 12. In practice, the region detection unit 13 cuts out the designated region, from the image displayed on the display device 20.

First, the region detection unit 13 adds labels to pixels of parts in which seeds are drawn for cutting out designated regions based on information regarding seeds. In the example of FIG. 3A, “label 1” is applied to a pixel corresponding to the trajectory (seed 1) drawn in the hair portion, and “label 2” is applied to a pixel corresponding to the portion other than the hair (seed 2).

Further, in an example of FIG. 3B, “label 1” is applied to a pixel corresponding to the trajectory (seed 1) drawn in the hair portion, “label 2” is applied to a pixel corresponding to the trajectory (seed 2) drawn in the face portion, and “label 3” is applied to a pixel corresponding to the portion (seed 3) other than the hair and the face. In the present exemplary embodiment, applying labels in this manner is referred to as “labeling”.

Although details will be described later, a designated region is cut out by using a region expanding method for expanding a region, by repeating a process of connecting if the pixel values are close to each other or a process of not connecting if the pixel values are far from each other, based on the closeness of pixel values of the pixel on which seeds are drawn and the adjacent pixel.

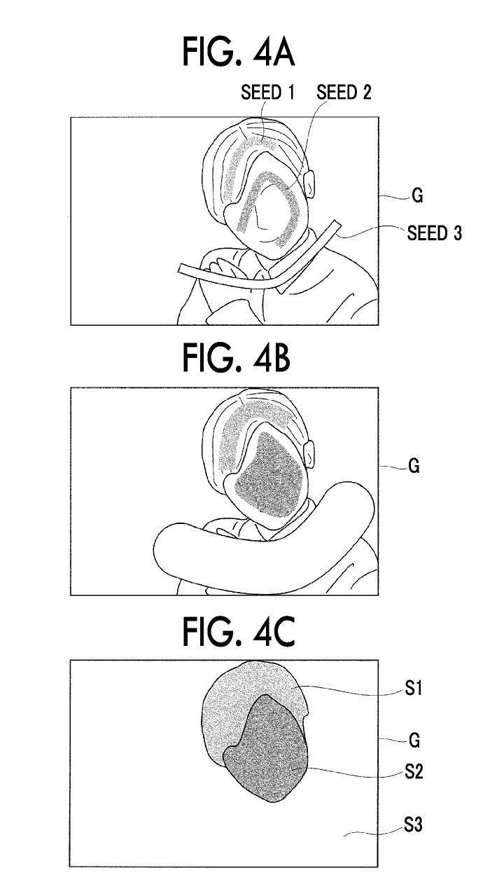

FIGS. 4A to 4C illustrate aspects in which designated regions are cut out from the image G illustrated in FIG. 3B by the region expanding method.

Among these, FIG. 4A illustrates a state in which trajectories are drawn as seeds on the image G illustrated in FIG. 3B.

As illustrated in FIG. 4B, regions are gradually expanded in the designated regions, from the points in which trajectories are drawn as seeds, and as illustrated in FIG. 4C, “first designated region (S1)”, “second designated region (S2)”, and “third designated region (S3)”, which are three designated regions, are finally cut out as the designated regions.

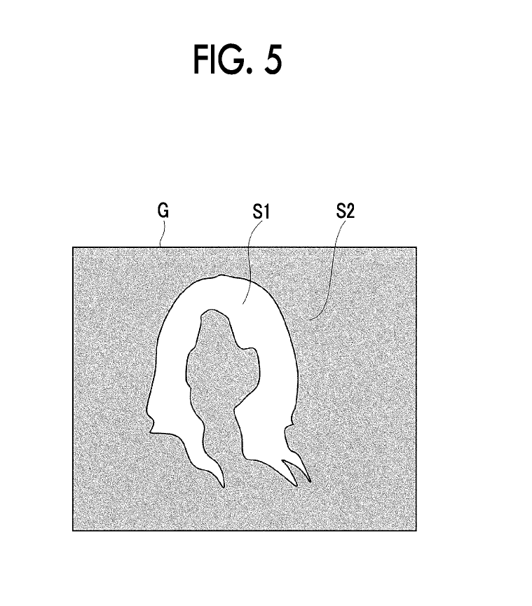

In addition, FIG. 5 illustrates an aspect in which “first designated region (S1)” and “second designated region (S2)” are cut out by the region expanding method, for the image G illustrated in FIG. 3A.

By adopting the method described above, even if the designated region has a complicated shape, the user may cut out of the designated region more intuitively and easily.

The region switching unit 14 switches plural designated regions. In other words, when there are plural designated regions, the user selects a designated region to be intended to be subjected to an image adjustment, and the region switching unit 14 cuts out the designated region according thereto.

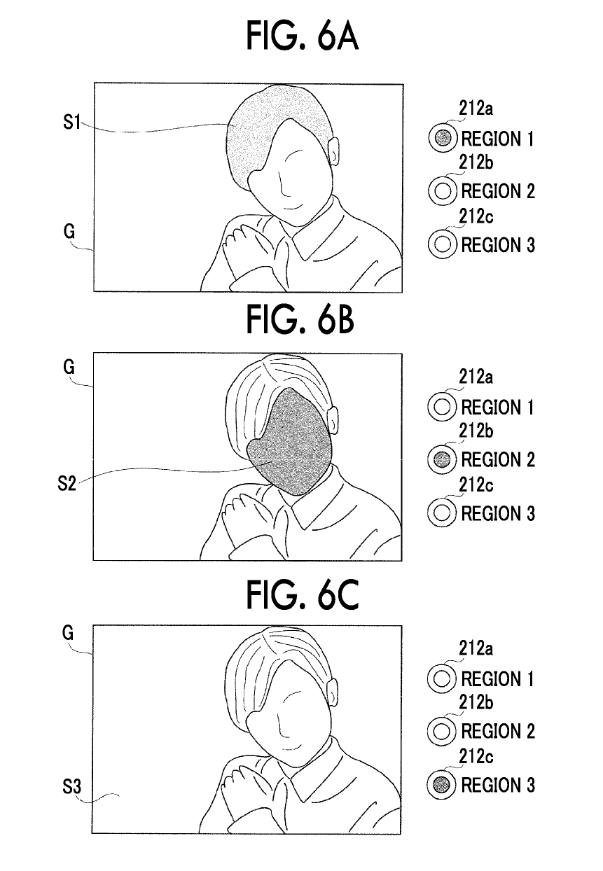

FIGS. 6A to 6C illustrate examples of screens displayed on the display screen 21 of the display device 20 when the user selects a designated region.

In the examples illustrated in FIGS. 6A to 6C, the image G in a state of the designated region being selected is displayed on the left part of the display screen 21, and radio buttons 212a, 212b, and 212c for selecting one of “region 1”, “region 2”, and “region 3” are displayed on the right part of the display screen 21. In this case, “region 1” corresponds to “first designated region (S1)”, “region 2” corresponds to “second designated region (S2)”, and “region 3” corresponds to “third designated region (S3)”. If the user selects the radio buttons 212a, 212b, and 212c by using the input device 30, the designated region is switched.

FIG. 6A illustrates a state in which the radio button 212a is selected, and “first designated region (S1)” which is an image region of the hair portion is selected as the designated region. If the user selects the radio button 212b, as illustrated in FIG. 6B, the designated region is switched to “second designated region (S2)” which is the image region of the face portion. If the user selects the radio button 212c, as illustrated in FIG. 6C, the designated region is switched to “third designated region (S3)” which is the image region of the part other than the hair and face.

In fact, the result from the operations described in FIGS. 6A to 6C is acquired as user instruction information, by the user instruction receiving unit 12, and the switching of the designated region is performed by the region switching unit 14.

The image processing unit 15 actually performs image processing on the selected designated region.

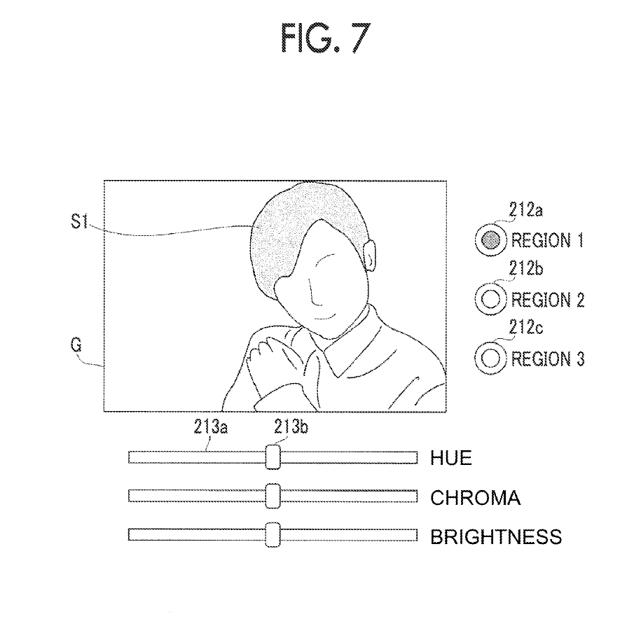

FIG. 7 illustrates an example of a screen displayed on the display screen 21 of the display device 20 when the image processing is performed.

Here, an example of adjusting the hue, the saturation, and the brightness of the selected designated region is illustrated. In this example, an image G in a state of the designated region being selected is displayed on the upper left side of the display screen 21, and the radio buttons 212a, 212b, and 212c for selecting one of “region 1”, “region 2”, and “region 3” are displayed on the upper right side of the display screen 21. Here, the radio button 212a is selected among the radio buttons, and “first designated region (S1)” which is the image region of the hair portion is selected as the designated region. Further, the switching of the designated region is possible by operating the radio buttons 212a, 212b, and 212c, similarly to the case of FIGS. 6A to 6C.

Further, slide bars 213a and sliders 213b for adjusting “hue”, “saturation”, and “brightness” are displayed on the lower side of the display screen 21. The slider 213b is moved in a left-right direction in FIG. 7 on the slide bar 213a by the operation of the input device 30, and is capable of slide. The slider 213b is located in the center of the slide bar 213a in the initial state, and represents the state before adjustment of “hue”, “saturation”, and “brightness” at this position.

If the user slides the slider 213b of one of “hue”, “saturation”, and “brightness” on the slide bar 213a in a left-right direction in FIG. 7 by using the input device 30, the image processing is performed on the selected designated region, and the image G displayed on the display screen 21 also changes correspondingly. In this case, if the slider 213b is slid in a right direction in FIG. 7, an image processing for increasing one of the corresponding “hue”, “saturation”, and “brightness” is performed. In contrast, if the slider 213b is slid in a left direction in FIG. 7, an image processing for decreasing one of the corresponding “hue”, “saturation”, and “brightness” is performed.

Returning to FIG. 2 again, the image information output unit 16 outputs the image information obtained after the image processing is performed as described above. The image information obtained after the image processing is performed as described above is transmitted to the display device 20. Then, an image is displayed based on the image information on the display device 20.

<Description of Region Detection Unit>

Next, a more detailed description will be given of a method in which the region detection unit 13 cuts out the designated region by the region expanding method.

Here, a description will be given of a region expanding method in the related art.

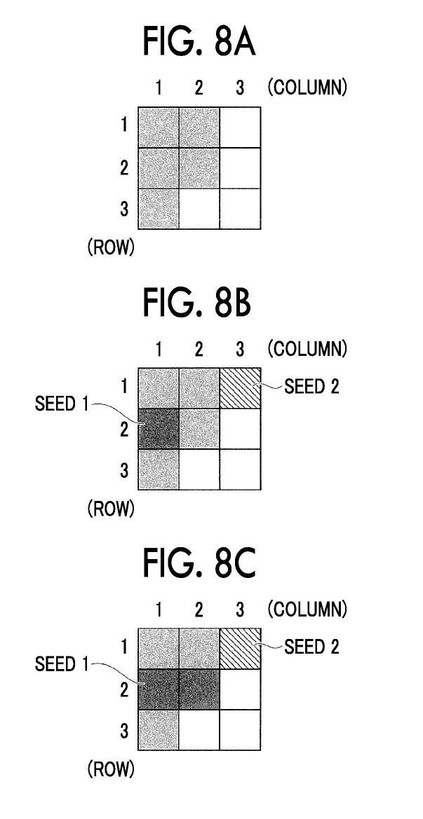

FIGS. 8A to 8C are diagrams describing the region expanding method in the related art.

Among these, FIG. 8A is an original image configured with three vertical pixels and three horizontal pixels (3×3=9 pixels). The original image has two image regions. In FIG. 8A, two image regions are represented by a difference in densities of colors of respective pixels. It is assumed that the pixel values contained in respective image regions represent values close to each other.

As illustrated in FIG. 8B, a seed 1 is given to a pixel located in row 2 and column 1, and a seed 2 is given to a pixel located in row 1 and column 3.

At this time, it is considered the case of determining whether a pixel located at row 2 and column 2, which is a center pixel, belongs to a designated region including the seed 1 or a designated region including the seed 2. Here, with respect to the center pixel, the pixel value of the center pixel is compared to the pixel value of the seed which is present among eight adjacent pixels adjacent to the center pixel. If the pixel values are close to each other, it is determined that the center pixel belongs to the designated region including the seed. In this case, two seeds which are the seed 1 and the seed 2 are included in eight adjacent pixels, but the pixel value of the center pixel is closer to the pixel value of the seed 1 than the pixel value of the seed 2, and thus it is determined that the center pixel belongs to the designated region including the seed 1.

As illustrated in FIG. 8C, the center pixel belongs to the region of the seed 1. In turn, the center pixel is treated as a new seed. In this case, “label 1” is applied to the center pixel, similarly to the seed 1.

In the region expanding method in the related art, a pixel adjacent to the seed pixel is selected as a target pixel to be determined as to whether or not the target pixel is included in the designated region (in the example described above, the center pixel), and the pixel value of the target pixel is compared to the pixel value of the seed which is included in the eight adjacent pixels of the target pixel. The target pixel is considered to belong to a region including the seed of which the pixel value is close to that of the target pixel, and label is applied to the target value. The region is expanded by repeating the above process. Once the pixel is labeled, the label is not changed thereafter.

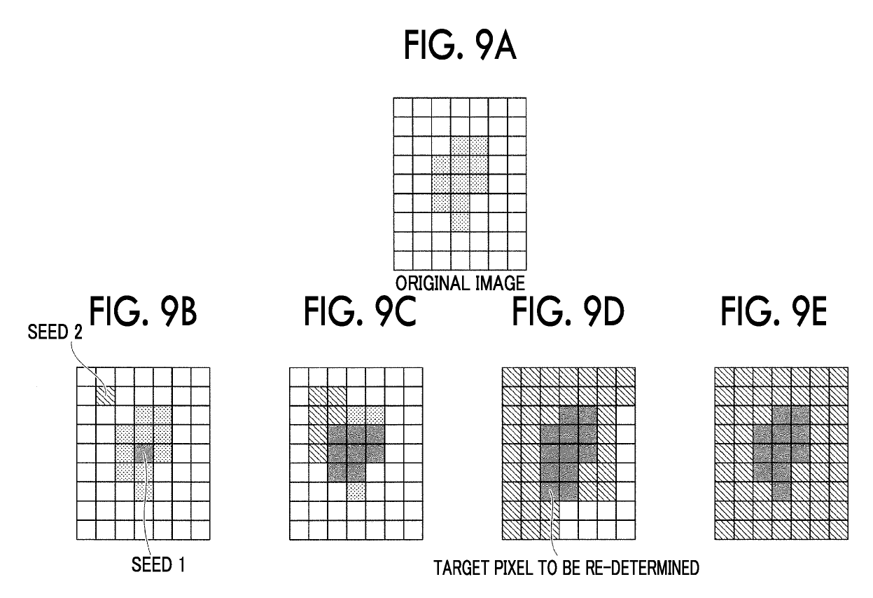

FIGS. 9A to 9E are diagrams illustrating aspects in which an image is divided into two designated regions, when two seeds are given, by the region expanding method in the related art.

Here, as illustrated in FIG. 9B, two seeds (a seed 1 and a seed 2) are given to the original image of FIG. 9A. Regions are expanded based on the respective seeds. In this case, as described above, it is possible to expand a region depending on the closeness of the pixel values of the seed and the adjacent pixels in the original image. At this time, when there is mutual conflict between regions as illustrated in FIG. 9C, the target pixel becomes a target pixel to be re-determined, and a region including the target value to be re-determined may be determined depending on the relationship between the pixel value of the target value to be re-determined and the pixel values of the adjacent pixels. At this time, the method described in the following document may be used.

V. Vezhnevets and V. Konouchine: “Grow-Cut”-Interactive Multi-Label N-D Image Segmentation”, Proc.Graphicon. pp. 150-156 (2005)

In the example of FIG. 9D, the target pixel to be re-determined is finally determined to be a region of the seed 2, and the pixels are divided into and converged on two regions, based on two seeds as illustrated in FIG. 9E. In addition, in the example, the case of being divided into two regions is illustrated, but three or more seeds may be given and the image may be divided into three or more regions.

In this manner, in the region expanding method in the related art, focusing on the target pixel, a designated region including the target pixel is determined by comparing the pixel value of the target pixel to the pixel values of seed pixels present among eight adjacent pixels. In other words, this method is a so-called “passive” method in which the target pixel changes under the influence from the eight adjacent pixels.

However, in the region expanding method in the related art, since one pixel is required to be selected as a target pixel at a time and labelled, there is a problem that a processing speed is likely to be slow. In such places in which regions are entangled, an accuracy of division is likely to be low.

Thus, in the present exemplary embodiment, the region detection unit 13 has a following configuration, and thus the suppression of the above problem is aimed.

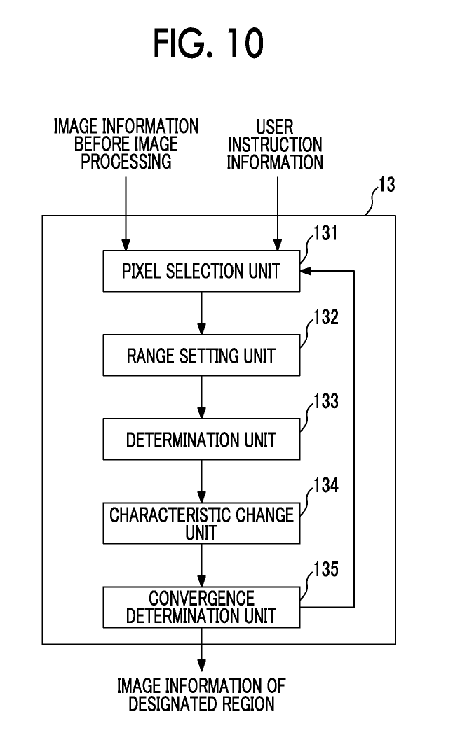

FIG. 10 is a block diagram illustrating a functional configuration example of the region detection unit 13 in the present exemplary embodiment.

As illustrated, the region detection unit 13 of the present exemplary embodiment includes a pixel selection unit 131, a range setting unit 132, a determination unit 133, a characteristic change unit 134, and a convergence determination unit 135.

Hereinafter, descriptions will be separately given of first to fourth exemplary embodiments, with respect to the region detection unit 13 illustrated in FIG. 10.

### First Exemplary Embodiment

First, a description will be given of the first exemplary embodiment of the region detection unit 13.

In the first exemplary embodiment, the pixel selection unit 131 selects a reference pixel among pixels belonging to a designated region. Here, “the pixel belonging to the designated region” is, for example, a pixel included in a representative position designated by the user, in other words, a seed pixel described above. Further, pixels which are newly labelled by the region expansion are included.

Here, the pixel selection unit 131 selects one pixel from pixels belonging to the designated region, as a reference pixel.

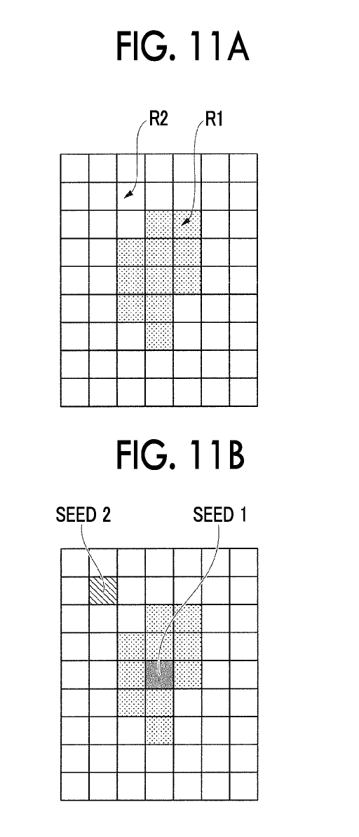

FIG. 11A is a diagram illustrating an original image to be divided into designated regions. As illustrated, the original image is configured with 63 pixels of nine vertical pixels and seven horizontal pixels (9×7=63 pixels), and has an image region R1 and an image region R2. The respective pixel values of the pixels included in the image region R1 and the respective pixel values of the pixels included in the image region R2 represent values close to each other. As described below, it is assumed that the image is divided, with the image region R1 and the image region R2 as respective designated regions.

In order to simplify the description, as described in FIG. 11B, representative positions designated by the user respectively include one pixel, at two positions respectively designated at the image region R1 and the image region R2, and it is assumed that the pixel selection unit 131 selects the one pixel as a reference pixel. In FIG. 11B, the reference pixels are illustrated by the seed 1 and the seed 2.

Although details will be described later, the seed 1 and the seed 2 are respectively labelled, and have strength. Here, it is assumed that the label 1 and the label 2 are respectively applied to the seed 1 and the seed 2, and strength is set to 1 as an initial value for both seeds.

The range setting unit 132 sets a first range which is set for the reference pixel and a range of target pixels (first target pixels) to be determined as to whether or not target pixels are included in the designated region including the reference pixel.

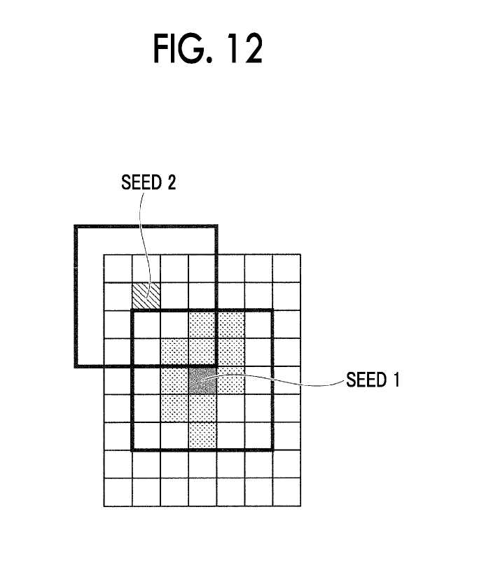

FIG. 12 is a diagram describing a first range.

As illustrated, the seed 1 and the seed 2, which are reference pixels, are respectively selected in the image region R1 and the image region R2. It is assumed that respective ranges of five vertical pixels×five horizontal pixels are set to the first ranges so as to be arranged around the seed 1 and the seed 2. In FIG. 12, the ranges are represented as ranges within frames indicated by bold lines.

Although details will be described later, in the present exemplary embodiment, it is preferable that the first range be variable, and the range be reduced as a process progresses.

The determination unit 133 determines a designated region including target pixels (first target pixels) in the first range.

The determination unit 133 sets respective 24 pixels except for the seed 1 or the seed 2 among 25 pixels included in the first range, to target pixels (first target pixels) to be determined as to whether the pixels are included in the designated region. The determination unit 133 determines whether the target pixels are included in the designated region (first designated region) including the seed 1 or the designated region (second designated region) including the seed 2.

It is possible to employ the closeness of the pixel values as a determination criterion at this time.

Specifically, when the above 24 pixels included in the first range are numbered for convenience, and an i-th (i is any integer value of 1 to 24) target pixel is set to Pᵢ, in a case in which the color data of the pixel is RGB data, the color data thereof may be represented as Pᵢ=(Rᵢ, Gᵢ, Bᵢ). If the reference values of the seed 1 and the seed 2 are assumed to P₀ in the same manner, the color data thereof may be represented as P₀=(R₀, G₀, B₀). Then, Euclidean distance dᵢ of the RGB values represented by the following expression 1 is considered as the closeness of the pixel values.

dᵢ=\sqrt{(Rᵢ−Rₒ)²+(Gᵢ−Gₒ)²+(Bᵢ−Bₒ)²} [Expression 1]

When the Euclidean distance dᵢ is equal to or less than a predetermined threshold, the determination unit 133 determines that the target pixel belongs to the first designated region or the second designated region. In other words, when the Euclidean distance dᵢ is equal to or less than the predetermined threshold, the pixel values of the reference pixel P₀ and the target pixel Pᵢ are considered to be closer, such that in this case, it is assumed that the reference pixel P₀ and the target pixel Pᵢ belong to the same designated region.

Although there is a case in which the Euclidean distance dᵢ is equal to or less than a predetermined threshold with respect to both the seed 1 and the seed 2, in this case, the determination unit 133 assumes that the target pixel belongs to the designated region on the side having a shorter Euclidean distance dᵢ.

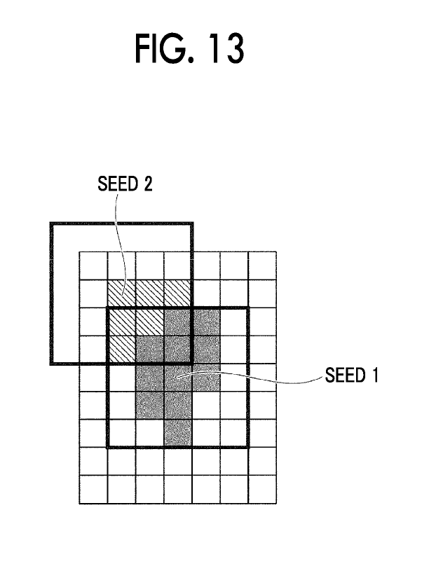

FIG. 13 is a diagram illustrating a result of performing determination on the target pixels belonging to the first range illustrated in FIG. 12, based on the Euclidean distance dᵢ.

Here, those which become the same black as the seed 1 are determined to be the pixels belonging to the designated region 1, and those which become the same gray as the seed 2 are determined to be the pixels belonging to the designated region 1. In addition, the pixels of white color, in this case, are determined not to belong to any designated region.

There is an effect of automatically spreading the seed, with respect to given seed, by operating the determination unit 133 as described above. In the present exemplary embodiment, for example, it is possible to cause the determination unit 133 to perform the operation only at the first time. Alternatively, it is possible to cause the determination unit 133 to perform the operation at the first few times.

The characteristic change unit 134 changes the characteristics given to the target pixel (first target pixel) in the first range.

Here, “characteristics” refer to the label and the strength given to the pixel.

The “label” represents a designated region including the pixel, as described above, “label 1” is applied to a pixel belonging to the designated region 1, and “label 2” is applied to a pixel belonging to the designated region 2. Here, since the label of the seed 1 is label 1 and the label of the seed 2 is label 2, when the pixel is determined to belong to the designated region 1 by the determination unit 133 (pixel in black in FIG. 13), the label 1 is applied to the pixel. Further, when the pixel is determined to belong to the designated region 2 in the determination unit 133 (pixel in gray in FIG. 13), the label 2 is applied to the pixel.

The “strength” is strength of the designated region corresponding to the label, and represents the degree of possibility that a pixel belongs to the designated region corresponding to the label. The greater the strength is, the greater the possibility that the pixel belongs to the designated region corresponding to the label is. The smaller the strength is, the smaller the possibility that the pixel belongs to the designated region corresponding to the label is. The strength is determined in the following manner.

The strength of the pixel included in the representative position which is first designated by the user is set to 1 as an initial value. In other words, with respect to the pixels of the seed 1 and the seed 2 prior to expanding the region, the strength is 1. Further, with respect to the pixel to which the label is not yet applied, the strength is 0.

The influence of the pixel having the given strength on the adjacent pixels is considered.

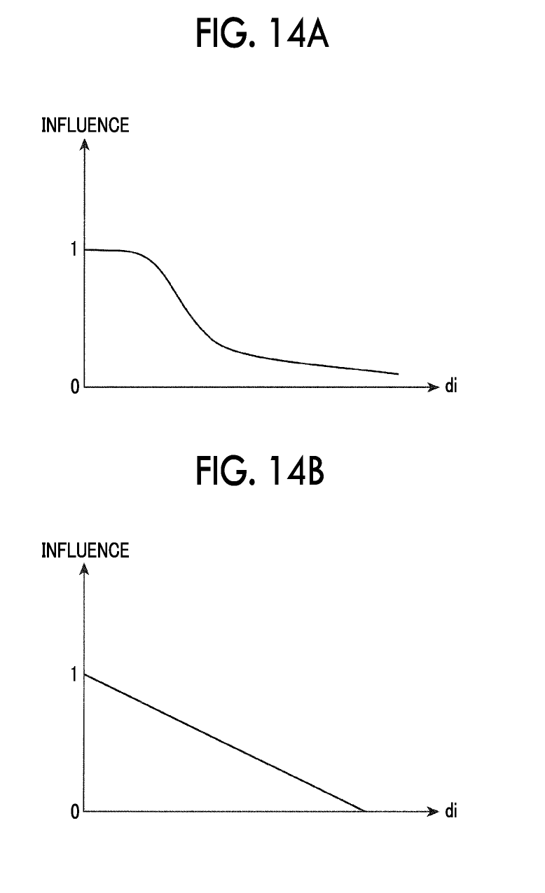

FIGS. 14A and 14B are diagrams illustrating a method of determining influence. In FIGS. 14A and 14B, the horizontal axis represents Euclidean distance dᵢ, and the vertical axis represents the influence.

The Euclidean distance dᵢ is the Euclidean distance dᵢ of the pixel value determined between the pixel to which the strength is given and the pixel located in the vicinity of the pixel. For example, a monotonically decreasing non-linear function is determined as illustrated in FIG. 14A, and the influence is assumed to be a value determined by the monotonically decreasing function with respect to the Euclidean distance dᵢ.

In other words, the smaller the Euclidean distance dᵢ is, the greater the influence is. In contrast, the greater the Euclidean distance dᵢ is, the smaller the influence is.

In addition, the monotonically decreasing function is not limited to the shape like FIG. 14A, and is not particularly limited as long as it is a monotonically decreasing function. Accordingly, it may be a monotonically decreasing linear function like in FIG. 14B. Further, the monotonically decreasing function may be a piecewise-monotonically decreasing linear function in which the influence is linear in a specific range of the Euclidean distance dᵢ and is non-linear in other range.

The strength of the pixel determined to belong to the designated region is obtained by multiplying influence by the strength of the reference pixel. For example, when the strength of the reference pixel is 1 and the influence given to the target pixel adjacent to the left side of the reference pixel is 0.9, the strength given when the target pixel adjacent to the left side is determined to belong to the designated region becomes 1×0.9=0.9. For example, when the strength of the reference pixel is 1 and the influence given to the target pixel adjacent to two left side of the reference pixel is 0.8, the strength given when the target pixel is determined to belong to the designated region becomes 1×0.8=0.8.

Using the above calculation method, the determination unit 133 may perform determination based on the strength given to the target pixel (first target pixel) in the first range. At this time, when the target pixel does not have a label, it is determined that the target pixel is included in the designated region including the reference pixel. In contrast, when the target pixel already has a label for another designated region, it is determined that the target pixel is included in the designated region on the side having large strength. Then, in the former case, the same label as the reference pixel is applied. In the latter case, the label of the side having large strength among characteristics is applied. Even for the pixel to which a certain label is applied once, the applied label may be changed into another label even by the method.

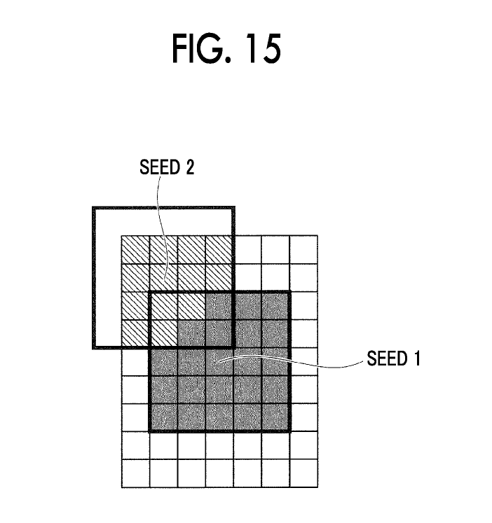

FIG. 15 illustrates a result of performing determination on a target pixel in the first range illustrated in FIG. 12 by a method based on the strength.

The first ranges illustrated in FIG. 12 partially overlap in the seed 1 and the seed 2. A non-overlapped portion in the first range, that is, the portions in which the first ranges do not conflict in the seed 1 and seed 2 are not labelled in this case, such that the portions are labelled by the same label as those of the seed 1 or the seed 2 which are all reference pixels. In contrast, a portion in which the first ranges overlap in the seed 1 and the seed 2, that is, the first ranges conflict is labelled by the label of the side having stronger strength. As a result, the label is applied as illustrated in FIG. 15.

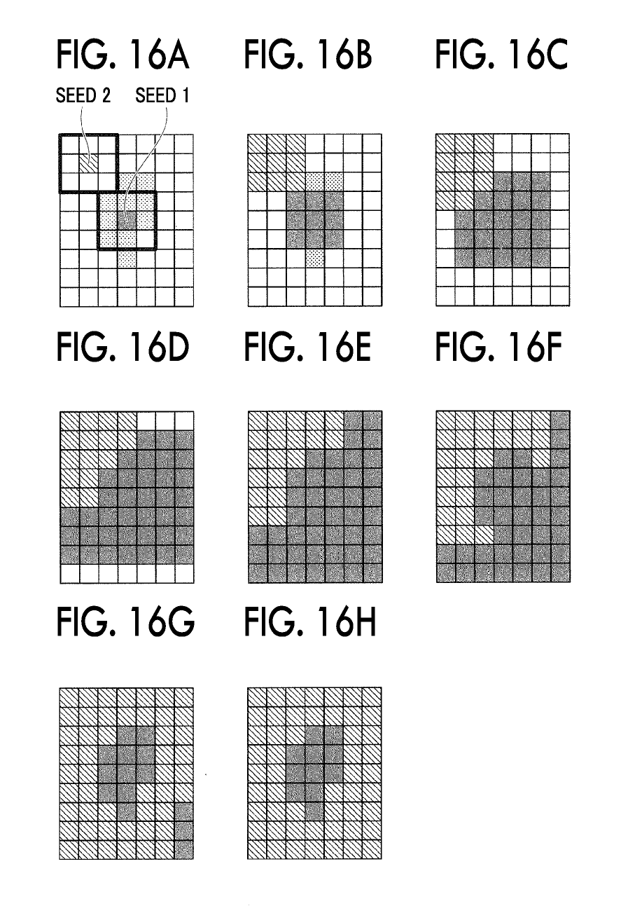

FIGS. 16A to 16H are diagrams illustrating an example of a process of sequentially labelling by the region expanding method based on the strength.

Among these, FIG. 16A illustrates the first ranges which are set at this time. In other words, the seed 1 and the seed 2 which are reference pixels are selected for the image region R1 and the image region R2. Ranges of three vertical pixels×three horizontal pixels so as to be positioned around the seed 1 and the seed 2 are set to first ranges. In FIG. 16A, the ranges are represented as ranges within frames indicated by bold lines.

FIG. 16B illustrates a result of performing determination on the target pixels in respective first ranges of the seed 1 and the seed 2. In this case, since the respective first ranges of the seed 1 and the seed 2 do not overlap, the target pixels in respective first ranges are labelled by the same label as that of the seed 1 or the seed 2 which are all reference pixels.

FIG. 16C illustrates an updated result of performing region expansion. In this case, similarly to FIG. 15, portions in which the respective first ranges at the seed 1 and the seed 2 do not overlap are labelled by the same label as that of the seed 1 or the seed 2 which are all reference pixels. Portions in which the first ranges overlap at the seed 1 and the seed 2 are labelled by the label of the side having the stronger strength.

Even when the target pixel is already labelled by another label, the strength that the target pixel has currently is compared to the strength exerted from the reference pixel, and the target pixel is labelled by the label on the side having the stronger strength. In addition, the strength is the strength of the stronger side. In other words, in this case, the label and the strength of the target pixel are changed.

Hereinafter, the labelled target pixel is selected as a new reference pixel, the region is sequentially updated as illustrated in FIG. 16D to 16H. Finally, as illustrated in 16H, division into the first designated region and the second designated region is performed.

In the example described above, the description has been made of the case where the color data is RGB data, but the color data is not limited thereto, and may be color data in other color spaces such as L*a*b*data, YCbCr data, and HSV data. Further, when for example, HSV data is used as color data without using all color components, only values of H and S may be used.

When it is determined that the target pixel belongs to the designated region in the manner described above, the label and the strength are changed in the characteristic change unit 134.

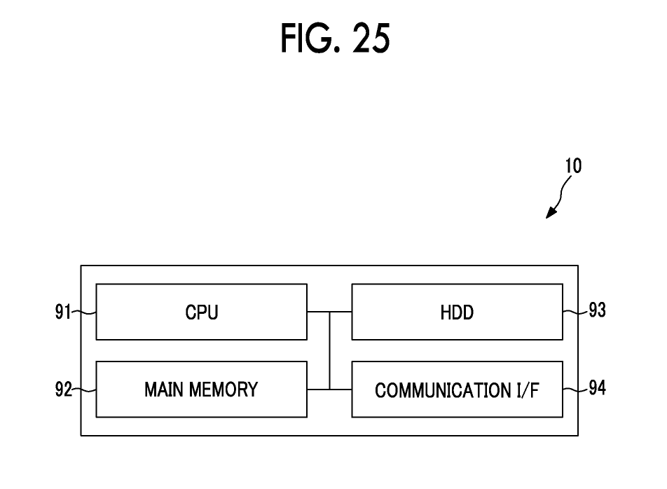

Information regarding the label, the strength, and the influence are stored in practice in a main memory 92 which will be described later (refer to FIG. 25), as information for each pixel. When the label, the strength, and the influence are read from the main memory 92 as necessary and are changed, the rewriting of these types of information is performed. Thus, the processing speed of the region detection unit 13 is improved.

In addition, the processes of the pixel selection unit 131, the range setting unit 132, the determination unit 133, and the characteristic change unit 134, which are described above, are repeated until the processes are converged. In other words, as described in FIG. 13, a pixel is newly determined to belong to the designated region 1 or the designated region 2 is newly selected as a reference pixel, and determination as to whether the target pixel belongs to the designated region 1 or the designated region 2 is performed on the target pixel within the first range. The process is repeated and updated, such that the regions subjected to characteristic change such as labelling are gradually expanded, and cut out of the designated region 1 and the designated region 2 are performed. Further, according to the method (region expanding method), even for the pixel to which a certain label is applied once, the applied label may be changed into another label.

The convergence determination unit 135 determines whether the series of processes are converged.

The convergence determination unit 135 determines that the series of processes are converged, for example, when there is no pixel of which the label is changed. The maximum number of updates is predetermined, and when the number of updates has reached the maximum number of updates, it is possible to regard this as processes that are converged.

In the region expanding method according to the first exemplary embodiment described above, target pixels to be determined as to whether or not the target pixels are included in the designated regions are pixels belonging to the first ranges except for the seed 1 and the seed 2 which are reference pixels. Then, the designated region including the target pixel is determined by comparing the pixel value of the target pixel to the pixel value of the reference pixel. In other words, the method is a so-called “offensive” method in which pixels are changed under the influence of the reference pixel.

Further, in the region expanding method, the label and the strength of whole images immediately before the region expansion is performed are once stored. The determination unit 133 determines designated regions including the target pixels within the first range which are set by the reference pixels which are respectively selected from the designated regions, and performs the region expansion. After the determination, the label and the strength which are stored in the characteristic change unit 134 are changed. The label and the strength after the change are stored as the label and the strength of whole images immediately before performing again the region expansion, and the region expansion is performed again. In other words, in this case, the method is a so-called “synchronous” region expanding method in which the label and the strength of whole images are changed all at once.

Furthermore, in the region expanding method, the first range may be fixed or changed. When changing the first range, it is preferable that the range be changed to be smaller depending on the number of updates. Specifically, for example, if a first range is set to be greater first, and the number of updates is equal to or greater than a specified number of updates, the first range is reduced. Plural specified number of updates may be set, and the first range may be reduced in a stepwise manner. In other words, at the first stage, the first range is set to be greater, and thus a processing speed is fast. Further, at a step in which the update is progressed to some extent, the separation accuracy of the designated region is further improved by reducing the first range. In other words, both the improvement in the processing speed and the separation accuracy of the cut-out of the designated region are achieved.

### Second Exemplary Embodiment

Next, a description will be given of a second exemplary embodiment of the region detection unit 13.

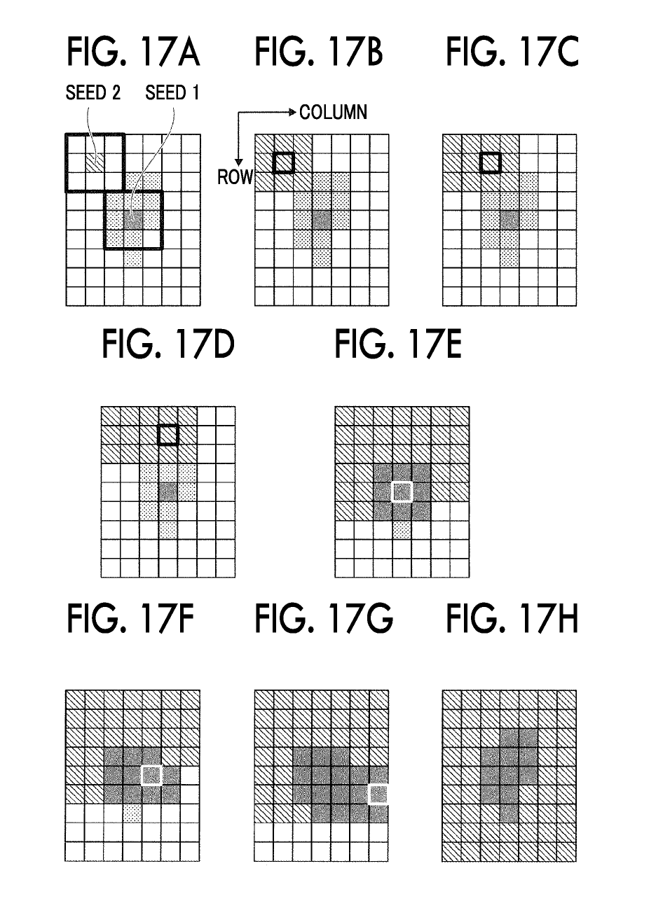

FIGS. 17A to 17H are diagrams illustrating an example of a process of sequentially labelling by a region expanding method according to the second exemplary embodiment.

FIG. 17A illustrates first ranges which are set at this time, and is a diagram similar to FIG. 16A.

In the present exemplary embodiment, the determination unit 133 first determines whether or not the target pixels within the first range belong to a certain designated region, based on a seed 2 which is set at the position of row 2 and column 2, as illustrated in FIG. 17B. Then, as illustrated in FIGS. 17C and 17D, it is determined whether or not the target pixels within the first range belong to a certain designated region while moving the reference pixel by one pixel at a time to the right direction in FIGS. 17C and 17D. The determination is performed based on the strength, and is similar to the case of FIGS. 16A to 16H.

After the pixel on the right end in FIGS. 17A to 17H is determined to be the target pixel, the reference pixel is next moved to the third column, and it is determined whether or not the target pixels within the first range belong to a certain designated region while moving the reference pixel by one pixel at a time to the right direction in FIGS. 17A to 17H. After the pixel on the right end in FIGS. 17A to 17H is determined to be the target pixel, the reference pixel is moved to the next column. These processes are repeated as illustrated in FIGS. 17E to 17G, and performed until the reference pixel is moved to the lower right end in FIGS. 17A to 17H. It may be said that the determination unit 133 performs determination while moving the reference pixel so as to scan each reference pixel.

After the reference pixel has reached the lower right end portion and the pixel is no longer moved, the same process is performed by moving the reference pixel in an opposite direction to the case described above so as to move the reference pixel to the upper left end portion. This makes the reference pixel be reciprocated once. Hereinafter, the reciprocal movement of the reference pixel is repeated until the processes are converged.

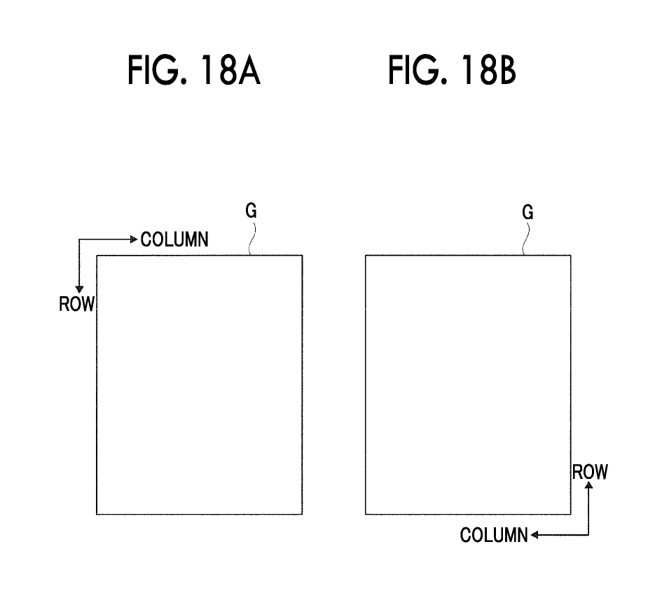

It may be said that the same process is performed by reversing the order of rows and columns as illustrated in FIG. 18. Further, it may be said that the reference pixel is further moved so as to scan the reference pixel in the opposite direction when the reference pixel has reached the end position (in this case, a lower right end portion or an upper left end portion).

Finally, as illustrated in FIG. 17H, division into the first designated region and the second designated region is performed.

According to the region expanding method, convergence is faster and a processing speed is faster compared to the method described in FIGS. 16A to 16H. By further moving the reference pixel so as to scan the reference pixel in the opposite direction when the reference pixel has reached the end position, a portion to be slowly converged hardly occurs, and convergence becomes faster.

In addition, in the second exemplary embodiment, the operations of the pixel selection unit 131, the range setting unit 132, the characteristic change unit 134, and the convergence determination unit 135, except for the determination unit 133, are the same as in the first exemplary embodiment. Similarly, the first range may be fixed or changed, and when the first range is changed, it is preferable that the range be changed so as to be reduced by the number of updates.

In the region expanding method, whenever the selected reference pixel is moved by one pixel at a time, a designated region including the target pixels within the first range is determined in the determination unit 133, and region expansion is performed. After the determination, the label and the strength stored in the characteristic change unit 134 are changed. In this case, the labels and strength of all images are not changed all at once, and only the target pixels within the first range determined whenever the reference pixel is moved by one pixel at a time are to be changed. The method is a so-called “asynchronous” region expanding method.

A subsequent description will be given of the operation of the region detection unit 13 in the first exemplary embodiment and the second exemplary embodiment.

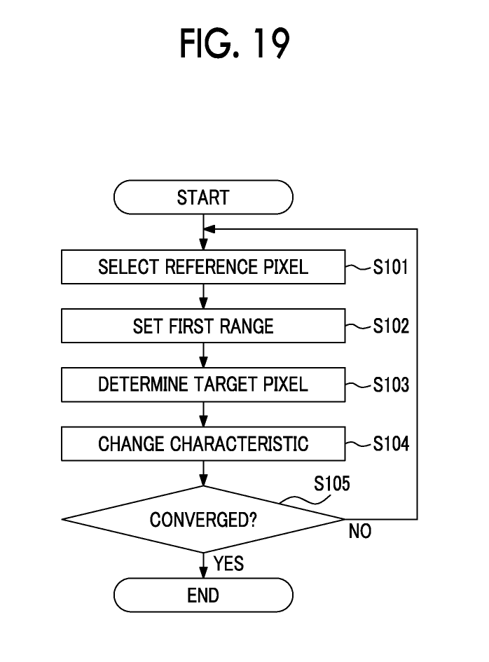

FIG. 19 is a flowchart describing the operation of the region detection unit 13 in the first exemplary embodiment and the second exemplary embodiment.

Hereinafter, the operation of the region detection unit 13 will be described with reference to FIGS. 10 and 19.

First, the pixel selection unit 131 selects a reference pixel from the pixels belonging to the designated region (step 101). In the example of FIG. 11B, the pixel selection unit 131 selects the seed 1 and the seed 2 as the reference pixel.

Next, the range setting unit 132 sets a first range which is a range of the target pixel (first target pixel) to be determined as to whether or not the target pixels are included in the designated region with respect to the reference pixel (step 102). In the example of FIG. 11B, the range setting unit 132 sets the range of five vertical pixels×five horizontal pixels as the first range such that the pixels are positioned around the seed 1 and the seed 2.

Then, the determination unit 133 determines a designated region including the target pixels within the first range (step 103). At this time, the determination unit 133 determines that the target pixels belong to the side having stronger strength, in a portion in which there is a conflict between designated regions. Further, determination may be performed based on the Euclidean distance dᵢ of the pixel values and the designated region may be expanded.

The characteristic change unit 134 changes the characteristic of the target pixels that are determined to belong to a certain designated region by the determination unit 133 (step 104). Specifically, the characteristic change unit 134 applies labels to the target pixels and gives strength thereto.

Next, the convergence determination unit 135 determines whether the series of processes are converged (step 105). It may be determined that processes are converged when there is no pixel of which the label is changed as described above, and it may be determined that processes are converged when the number of updates reaches the predetermined maximum number of updates.

When the convergence determination unit 135 determines that the processes are converged (Yes in step 105), the process of cut out of the designated region is ended.

In contrast, when the convergence determination unit 135 determines that the processes are not converged (No in step 105), the process returns to step 101. In this case, the reference pixel selected in the pixel selection unit 131 is changed.

### Third Exemplary Embodiment

Next, a description will be given of a third exemplary embodiment of the region detection unit 13.

In the third exemplary embodiment, the pixel selection unit 131 selects one of the target pixels to be determined as to whether or not the target pixels are included in the designated region. The range setting unit 132 changes a second range which is set for the selected target pixels (second target pixels) and a range including reference pixels to be determined as to whether or not the target pixels are included in a certain designated region.

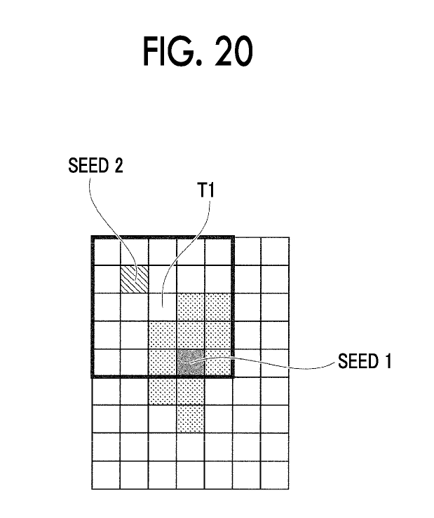

FIG. 20 is a diagram illustrating target pixels selected by the pixel selection unit 131 and a second range which is set by the range setting unit 132.

In FIG. 20, a reference pixel is set to a seed 1 and a seed 2 similarly to the case illustrated in FIG. 11B, with respect to the original image illustrated in FIG. 11A. A case in which one pixel indicated by T1 is selected as the target pixel (second target pixel) is illustrated. A range of five vertical pixels×five horizontal pixels so as to be positioned around the target pixel T1 is selected as the second range. In FIG. 20, the range is represented as a range within a frame indicated by a bold line.

The determination unit 133 determines whether or not the target pixel T1 belongs to a certain designated region. The determination unit 133 determines whether the target pixel T1 is included in the designated region (first designated region) including the seed 1 or the designated region (second designated region) including the seed 2.

At this time, it is determined whether the target pixel T1 belongs to the first designated region or the second designated region depending which pixel value of the seed 1 and the seed 2 as the reference pixel included in the second range the pixel value of the target pixel T1 is closer to. In other words, determination is performed based on the closeness of the pixel values.

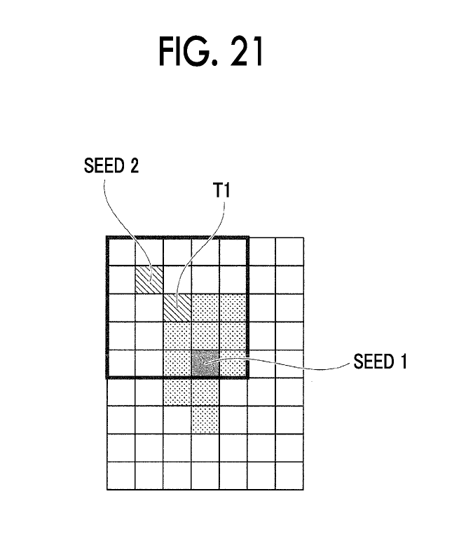

FIG. 21 is a diagram illustrating a result of determination according to the present exemplary embodiment.

In FIG. 21, the pixel value of the target pixel T1 is closer to the pixel value of the seed 2 than the pixel value of the seed 1, and as a result, it is determined that the target pixel T1 belongs to the second designated region.

The operations of the characteristic change unit 134, and the convergence determination unit 135 are the same as in the first exemplary embodiment.

In the case of the present exemplary embodiment, the processes by the pixel selection unit 131, the range setting unit 132, the determination unit 133, and the characteristic change unit 134 are repeated until the processes are converged. The process is repeated and updated, such that the region subjected to characteristic change such as labelling is sequentially expanded, and the cut out of the designated region 1 and designated region 2 is performed. Further, the second range is variable, and it is preferable that the range be sequentially reduced by the number of updates.

Specifically, first, the second range is set to be greater, and if a certain number of updates is equal to or greater than a specified number, the second range is reduced. Plural types of specified number of times may be specified, the second range may be reduced in a stepwise manner. In other words, at an initial stage, the second range is set to be smaller, such that a possibility of the presence of the reference pixel is high, and the determination becomes more efficient. At a step in which the update is progressed to some extent, the separation accuracy of the designated region is improved by reducing the second range.

In the region expanding method according to the present exemplary embodiment, focusing on a target pixel T1, and a designated region including target pixel T1 is determined by comparing the pixel value of the target pixel T1 to the pixel values of the reference pixel (seed 1 and seed 2) within the second range. In other words, the region expanding method is a so-called “passive” method in which the target pixel T1 changes under the influence from the reference pixel within the second range.

Although the method is similar to the region expanding method in the related art described in FIGS. 8A to 9E, the target pixel T1 is affected by the eight fixed adjacent pixels adjacent to the target pixel T1 in the region expanding method in the related art, but the region expanding method according to the third exemplary embodiment is characteristic in that the second range is variable. The determination is performed efficiently as described above by increasing the second range. If the eight adjacent pixels are fixed, the possibility of the reference pixel being present among them is reduced, and thus the efficiency of the determination is reduced.

The separation accuracy of the designated region is further increased by reducing the second range. Accordingly, the second range in the present exemplary embodiment is changed so as to be reduced depending on the number of updates.

In addition, in the case described above, the “synchronous” method similar to the first exemplary embodiment is used, but the “asynchronous” method similar to the second exemplary embodiment may be used. In other words, even in the case of the third exemplary embodiment, similarly to the description in FIGS. 17A to 18B, the determination may be made while the target pixel is moved. In this case, the determination unit 133 performs determination while moving the target pixel T1 so as to scan each pixel. When the target pixel has reached the end position (for example, the lower right end portion or upper left end portion of the image), the target pixel may be moved so as to be scanned in the opposite direction. Then, even in the third exemplary embodiment, the convergence is faster and the processing speed is faster by employing the method. In this case, the second range may be fixed or variable.

Next, a description will be given of the operation of the region detection unit 13 in the third exemplary embodiment.

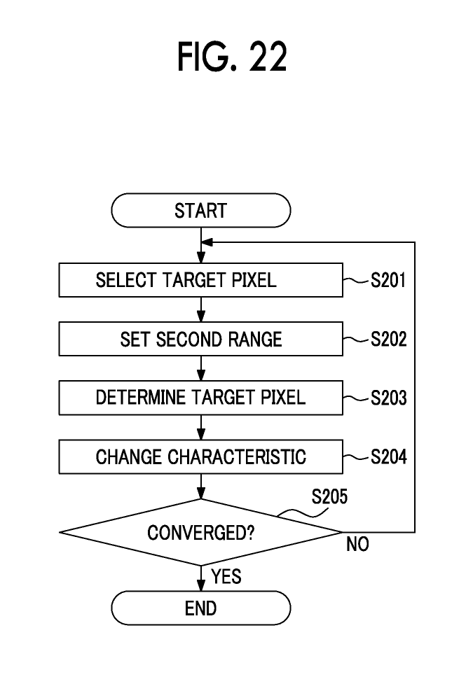

FIG. 22 is a flowchart describing the operation of the region detection unit 13 in the third exemplary embodiment.

Hereinafter, the operation of the region detection unit 13 will be described with reference to FIGS. 10 and 22.

First, the pixel selection unit 131 selects a target pixel (second target pixel) (step 201). In the example of FIG. 20, the pixel selection unit 131 selects a target pixel T1.

Next, the range setting unit 132 sets a second range which is an effective range of pixels that affects the determination for the target pixel (step 202). In the example illustrated in FIG. 20, the second range is set to a range of five vertical pixels×five horizontal pixels so as to be positioned around the target pixel T1, by the range setting unit 132.

Then, the determination unit 133 determines a designated region including the target pixel (step 203). In the case described above, the determination unit 133 performs determination based on the closeness between the pixel value of the target pixel T1 and the pixel value of the seed 1 or the seed 2.

When it is determined that the target pixel belongs to a certain designated region by the determination unit 133, the characteristic change unit 134 changes the characteristics (step 204). Specifically, labelling is performed on the target pixel T1, and strength is given thereto.

Next, the convergence determination unit 135 determines whether or not a series of processes are converged (step 205). It may be determined that processes are converged when there is no pixel of which the label is changed, and it may be determined that processes are converged when the number of updates reaches the predetermined maximum number of updates.

When the convergence determination unit 135 determines that the processes are converged (Yes in step 205), the process of cut out of the designated region is ended.

In contrast, when the convergence determination unit 135 determines that the processes are not converged (No in step 205), the process returns to step 201. In this case, the target pixel (second target pixel) selected in the pixel selection unit 131 is changed.

### Fourth Exemplary Embodiment

Next, a description will be given of a fourth exemplary embodiment of the region detection unit 13.

In the fourth exemplary embodiment, both the “offensive” region expanding method described in the first exemplary embodiment and the second exemplary embodiment and the “passive” region expanding method described in the third exemplary embodiment are used. In other words, in the fourth exemplary embodiment, a region is expanded while switching the “offensive” region expanding method and the “passive” region expanding method during the update.

In other words, the range setting unit 132 selects one of the “offensive” region expanding method and the “passive” region expanding method for use, at the time of update. When the “offensive” region expanding method is selected, the setting of the first range is performed. Then, the determination unit 133 determines a designated region including the target pixels within the first range. Further, when the “passive” region expanding method is selected, the setting of the second range is performed. The determination unit 133 determines a designated region including the target pixel. In other words, determination is performed while the setting of the first range and the setting of the second range are switched at least once.

The switching method is not particularly limited, for example, the “offensive” method and the “passive” method may be used alternately. A method may be used in which the “offensive” method is used for the number of updates which is predetermined first, and thereafter, the “passive” method is used up to the end. In contrast, a method may be used in which the “passive” method is used for a number of updates which is predetermined first, and thereafter, the “offensive” method is used up to the last. The case of “offensive” method may be used in one of the first exemplary embodiment and the second exemplary embodiment.

Even in the region expanding method of using both the “offensive” method and the “passive” method in this manner, the cut out of the designated region 1 and the designated region 2 is performed.

Further, in the present exemplary embodiment, the first range and the second range, which are set, may be fixed or variable. It is preferable that the first range and the second range be sequentially reduced gradually by the number of updates. Any one of the “synchronous” similar to the first exemplary embodiment and the “asynchronous” similar to the second exemplary embodiment may be used.

Next, a description will be given of an operation of the region detection unit 13 in the fourth exemplary embodiment.

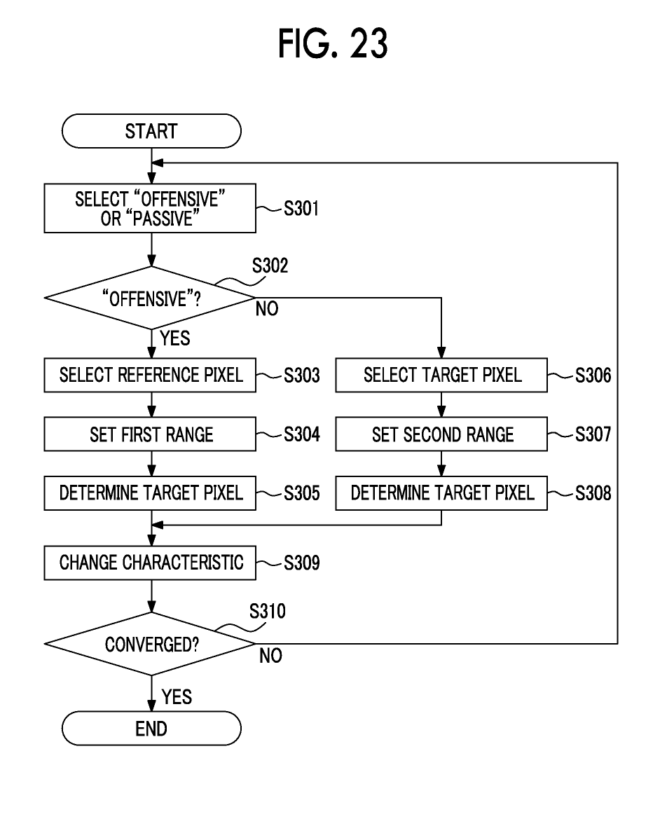

FIG. 23 is a flowchart describing the operation of the region detection unit 13 in the fourth exemplary embodiment.

Hereinafter, the operation of the region detection unit 13 is described using FIGS. 10 and 23.

The pixel selection unit 131 first selects one of the “offensive” and the “passive” for the use (step 301).

When the pixel selection unit 131 selects the “offensive” (Yes in step 302), the pixel selection unit 131 selects a reference pixel among pixels belonging to the designated region (step 303).

The range setting unit 132 sets a first range which is a range of target pixels (first target pixels) to be determined as to whether or not the target pixels are included in the designated region with respect to the reference pixel (step 304).

Then, the determination unit 133 determines a designated region including the target pixels within the first range (step 305).

In contrast, the pixel selection unit 131 selects the “passive” (No in step 302), the pixel selection unit 131 selects the target pixel T1 (second target pixel) (step 306).

The range setting unit 132 sets a second range which is an effective range of pixels that affects the determination for the target pixel T1 (step 307).

The determination unit 133 determines a designated region including the target pixel T1 (step 308).

Next, the characteristic change unit 134 changes the characteristics with respect to the target pixel T1 which is determined to belong to a certain designated region by the determination unit 133 (step 309).

The convergence determination unit 135 determines whether or not a series of processes are converged (step 310).

When the convergence determination unit 135 determines that the processes are converged (Yes in step 310), the process of cut out of the designated region is ended.

In contrast, when the convergence determination unit 135 determines that the processes are not converged (No in step 310), the process returns to step 301. In this case, the reference pixel or the target pixel (second target pixel) selected in the pixel selection unit 131 is changed.

According to the configuration of the region detection unit 13 described above in detail, when cut out of the designate region is performed using the region expanding method, the cut out of the designated region is faster as compared to the related art.

When the visibility of an image acquired in the image information acquiring unit 11 is poor, it is possible to enhance the visibility by performing Retinex process or the like in advance.

If the pixel value (brightness value) of a pixel position (x, y) of an image is set to I(x, y) and the pixel value of a pixel of which visibility is enhanced is set to I′(x, y), it is possible to enhance the visibility in the following manner, through the Retinex process.

I′(x,y)=αR(x,y)+(1−α)I(x,y)

α is a parameter for emphasizing reflectance, and R(x, y) is an estimated reflectance component. It is possible to enhance the visibility by emphasizing the reflectance component in the Retinex model. In the present exemplary embodiment, the calculation of R(x, y) may be performed by any method of the existing Retinex model. Assuming that 0≦α≦1, an original image is represented when α=0, and a reflectance image (maximum visibility) is represented when α=1. α may be adjusted by the user, or may be associated with the darkness of the image.

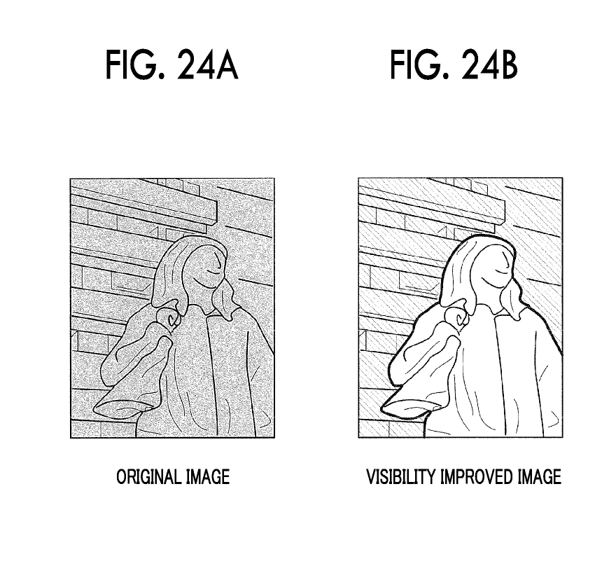

FIGS. 24A and 24B are conceptual diagrams in the case of improving visibility for the original image by performing a Retinex process.

Among these, FIG. 24A is an original image, and FIG. 24B is an image after the Retinex process is performed. By improving the visibility in this manner, the accuracy of cut out of the designated region is further improved.

The process performed in the region detection unit 13 described above may be understood as an image processing method for detecting a designated region from position information by acquiring image information of an image, acquiring position information indicating a representative position of a designated region which is designated as a specific image region from the image by a user, setting a first range that is a range of first target pixels which are target pixels which are set with respect to a reference pixel selected from pixels belonging to the designated region, and are determined as to whether or not the target pixels are included in the designated region, or changing a second range that is a range which is set for a second target pixel which is the selected target pixel, and includes a reference pixel for determining a designated region in which the second target pixel is included, and determining a designated region to which the first target pixel or the second target pixel belongs.

<Hardware Configuration Example of Image Processing Apparatus>

Next, a description will be given of a hardware configuration of the image processing apparatus 10.

FIG. 25 is a diagram illustrating a hardware configuration example of the image processing apparatus 10.

The image processing apparatus 10 is realized by a personal computer or the like as described above. As illustrated, the image processing apparatus 10 includes a central processing unit (CPU) 91 which is an arithmetic unit, the main memory 92 which is a storage unit, and a hard disk drive (HDD) 93. Here, the CPU 91 executes various programs such as operating system (OS) and application software. Further, the main memory 92 is a storage region for storing various programs and data used for the execution thereof, and the HDD 93 is a storage region for storing input data for various programs, output data from the various programs, and the like.

Further, the image processing apparatus 10 includes a communication interface (hereinafter, referred to as “communication I/F”) 94 for communicating with the outside.

<Description of Program>

The process performed by the image processing apparatus 10 in the exemplary embodiments described above, is provided as, for example, a program such as application software and the like.

Accordingly, in the exemplary embodiments, the process performed by the image processing apparatus 10 may be understood as a program causing a computer to execute an image information acquisition function of acquiring image information of an image, a position information acquisition function of acquiring position information indicating a representative position of a designated region which is designated as a specific image region from the image by a user, a region detecting function of detecting the designated region from the position information, the region detection function includes a range setting function of setting a first range that is a range of first target pixels which are target pixels which are set with respect to a reference pixel selected from pixels belonging to the designated region, and are determined as to whether or not the target pixels are included in the designated region, or changing a second range that is a range which is set for a second target pixel which is the selected target pixel includes a reference pixel for determining a designated region in which the second target pixel is included, and a determination unit function of determining a designated region to which the first target pixel or the second target pixel belongs.

The program for realizing the exemplary embodiments is provided through a communication section, and may be provided while being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image processing apparatus comprising:
an image information acquiring unit that acquires image information of an image;
a position information acquiring unit that acquires position information indicating a representative position of a designated region which is designated as a specific image region from the image by a user; and
a region detection unit that detects the designated region from the position information,
wherein region detection unit includes:
a range setting unit that sets a first range that is a range of first target pixels which are target pixels set with respect to a reference pixel selected from pixels belonging to the designated region and which are determined as to whether or not the target pixels are included in the designated region, or that changes a second range that is a range which is set for a second target pixel which is the selected target pixel and which includes a reference pixel for determining a designated region in which the second target pixel is included; and
a determination unit that determines a designated region to which the first target pixel or the second target pixel belongs.

2. The image processing apparatus according to claim 1,
wherein the region detection unit performs determination a plurality of times while changing selection of the reference pixel or the second target pixel, and
wherein the range setting unit sets the first range so as to be reduced, or changes the second range so as to be reduced.

3. The image processing apparatus according to claim 1,
wherein when the determination unit performs determination whether or not the first target pixel belongs to the designated region, the determination unit performs determination based on closeness between pixel values of the reference pixel and the first target pixel.

4. The image processing apparatus according to claim 2,
wherein when the determination unit performs determination whether or not the first target pixel belongs to the designated region, the determination unit performs determination based on closeness between pixel values of the reference pixel and the first target pixel.

5. The image processing apparatus according to claim 1, further comprising:
a characteristic change unit that changes a label indicating a designated region to which the first target pixel belongs, and strength of a designated region corresponding to the label, when the determination unit determines that the first target pixel belongs to the designated region,
wherein when the determination unit performs determination whether or not the first target pixel belongs to the designated region, the determination unit performs determination based on the strength.

6. The image processing apparatus according to claim 2, further comprising:
a characteristic change unit that changes a label indicating a designated region to which the first target pixel belongs, and strength of a designated region corresponding to the label, when the determination unit determines that the first target pixel belongs to the designated region,
wherein when the determination unit performs determination whether or not the first target pixel belongs to the designated region, the determination unit performs determination based on the strength.

7. The image processing apparatus according to claim 1,
wherein when the determination unit performs determination on a designated region to which the second target pixel belongs, the determination unit performs determination based on closeness of pixel values of the second target pixel and the reference pixel included in the second range.

8. The image processing apparatus according to claim 2,
wherein when the determination unit performs determination on a designated region to which the second target pixel belongs, the determination unit performs determination based on closeness of pixel values of the second target pixel and the reference pixel included in the second range.

9. The image processing apparatus according to claim 1,
wherein the region detection unit performs determination a plurality of times while changing selection of the reference pixel or the second target pixel, and
wherein the range setting unit switches setting of the first range and setting of the second range at least once.

10. The image processing apparatus according to claim 2,
wherein the region detection unit performs determination a plurality of times while changing selection of the reference pixel or the second target pixel, and
wherein the range setting unit switches setting of the first range and setting of the second range at least once.

11. An image processing apparatus comprising:
an image information acquiring unit that acquires image information of an image;
a position information acquiring unit that acquires position information indicating a representative position of a designated region which is designated as a specific image region from the image by a user; and
a region detection unit that detects the designated region from the position information,
wherein region detection unit includes:
a range setting unit that sets a first range that is a range of first target pixels which are target pixels set with respect to a reference pixel selected from pixels belonging to the designated region and which are determined as to whether or not the target pixels are included in the designated region, or that sets a second range that is a range which is set for a second target pixel which is the selected target pixel and which includes a reference pixel for determining a designated region in which the second target pixel is included; and
a determination unit that determines a designated region to which the first target pixel or the second target pixel belongs,
wherein the determination unit performs determination while moving the reference pixel or the second target pixel so as to scan each pixel.

12. The image processing apparatus according to claim 11,
wherein when the reference pixel or the second target pixel reaches an end position, the determination unit performs determination while further moving the reference pixel or the second target pixel so as to scan the pixels in an opposite direction.

13. An image processing method comprising:
acquiring image information of an image;
acquiring position information indicating a representative position of a designated region which is designated as a specific image region from the image by a user; and
detecting the designated region from the position information, by setting a first range that is a range of first target pixels which are target pixels set with respect to a reference pixel selected from pixels belonging to the designated region and which are determined as to whether or not the target pixels are included in the designated region, or changing a second range that is a range which is set for a second target pixel which is the selected target pixel and which includes a reference pixel for determining a designated region in which the second target pixel is included, and determining a designated region to which the first target pixel or the second target pixel belongs.

14. An image processing system comprising:
a display device that displays an image;
an image processing apparatus that performs an image processing on image information of the image displayed on the display device; and
an input device for the user to input an instruction for performing image processing to the image processing apparatus,
wherein the image processing apparatus includes:
an image information acquiring unit that acquires image information of the image;
a position information acquiring unit that acquires position information indicating a representative position of a designated region which is designated as an image region to be subjected to the image processing from the image by a user;
a region detection unit that detects the designated region from the position information; and
an image processing unit that performs image processing on the designated region, and
wherein region detection unit includes:
a range setting unit that sets a first range that is a range of first target pixels which are target pixels set with respect to a reference pixel selected from pixels belonging to the designated region and which are determined as to whether or not the target pixels are included in the designated region, or that changes a second range that is a range which is set for a second target pixel which is the selected target pixel and which includes a reference pixel for determining a designated region in which the second target pixel is included; and
a determination unit that determines a designated region to which the first target pixel or the second target pixel belongs.

15. A non-transitory computer readable medium storing a program causing a computer to execute a process for image processing, the process comprising:
an image information acquisition function of acquiring image information of an image;
a position information acquisition function of acquiring position information indicating a representative position of a designated region which is designated as a specific image region from the image by a user;
a region detecting function of detecting the designated region from the position information,
wherein the region detection function includes:
a range setting function of setting a first range that is a range of first target pixels which are target pixels set with respect to a reference pixel selected from pixels belonging to the designated region and which are determined as to whether or not the target pixels are included in the designated region, or of changing a second range that is a range which is set for a second target pixel which is the selected target pixel and which includes a reference pixel for determining a designated region in which the second target pixel is included; and
a determination unit function of determining a designated region to which the first target pixel or the second target pixel belongs.
